(19) United States
(12) Patent Application Publication
(10) Pub. No.: US 2009/0156428 A1
(43) Pub. Date: Jun. 18, 2009

(54) MULTI-MODE MICROARRAY APPARATUS AND METHOD FOR CONCURRENT AND SEQUENTIAL BIOLOGICAL ASSAYS

(76) Inventor: Alastair J. Malcolm, Scottsdale, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/325,462

(22) Filed: Dec. 1, 2008

Related U.S. Application Data
(60) Provisional application No. 60/991,552, filed on Nov. 30, 2007.

(51) Int. Cl. C40B 30/10

(52) U.S. Cl. 506/12

(57) ABSTRACT

A multi-mode, multiplexed array of probe elements of various forms attached to a common support and methods of using the array are disclosed. The array is used for the concurrent and/or sequential detection of combinations of more than one chemical and/or biological material, such as: target nucleic acid sequences, genomic DNA, pcr products, RNA (including microRNA), single nucleotide polymorphisms, proteins, peptides, carbohydrates, polysaccharides, phosphorylation or methylation state of target molecules, chromosomal abnormalities, and other biomolecules, moieties, metals, or chemical compounds in a biological sample. The method of the invention includes the deposition and/or in-situ synthesis of the various probe elements which comprise the array or group of arrays, the preparation and delivery of the target biological sample in forms suitable for concurrent and/or sequential detection, the hybridization methods of target to probe, the detection methods for target-probe interactions, and the use of such arrays in automated systems for research or diagnostic applications.

### CROSS-REFERENCE TO RELATED APPLICATIONS

This application claims the benefit of Application Ser. No. 60/991,552, entitled Multi-Mode Microarray Apparatus and Method for Concurrent and Sequential Biological Assays, filed Nov. 30, 2007, the contents of which are hereby incorporated herein by reference.

### FIELD OF INVENTION

This invention relates generally to biological arrays and methods of using the arrays for assessment of properties of human, animal and plant tissues and/or cells through generation of information on various components, e.g. nucleic acids, proteins, peptides, and other compounds of interest. More particularly, the invention relates to the concurrent and/or sequential measurement of various aspects of a biological sample using devices and methods which can capture multiple types of relevant biological and/or chemical information on a single substrate.

### BACKGROUND OF THE INVENTION

Arrays and microarrays generally include a plurality of probes that interact with a target material of interest, such that the arrays can be used to detect presence, absence, quantification, composition, sequence, chemical state and interactions of the target material of interest. Such arrays can be used to analyze chemical and biological materials or compounds, such as drugs, toxins, and various parts of cells. For example, microarrays can be used to measure changes in expression levels or to detect single nucleotide polymorphisms, micro RNA, messenger RNA, proteins, chemicals, antibodies, and the like.

Generally, the probes on each array are configured to interact with a single type of chemical or biological material (e.g., a protein or DNA) because each material type typically requires its own cell preparation, specific probes for detection of the material, and each probe type may require unique processing to attach the probe to a substrate. Thus, assessment of gene expression, protein expression, genotyping, methylation or phosphorylation state, presence of chemical compounds, carbohydrates, chromosomal abnormalities, and the like requires separate tests on a biological sample using specific arrays for each test. Use of a specific array for each test leads to additional sample processing time, array cost, and reagent costs. In addition, separate testing can also require more tissue or other biological sample than is available.

Abnormalities in the expression of multiple cell materials, such as genes and proteins, both in the timing and level of expression, are fundamental causes and/or indicators of cancer and other human, animal, insect and plant diseases. Using traditional techniques, multiple sample arrays are often required to understand such abnormalities. Use of such multiple arrays can be relatively expensive, time consuming, and require relatively large sample sizes. Accordingly, improved apparatus and methods are desired for analyzing various, multiple types of chemical and biological materials using suitable probes on a single substrate.

### SUMMARY OF THE INVENTION

The present invention provides a multi-mode, multiplexed biological and/or chemical assay method using an array, or group of arrays, of probe elements of various forms attached to a common support or substrate for concurrent and/or sequential detection of combinations of more than one target material.

The method and apparatus of the present invention have broad utility in human, animal and plant health management. By way of particular example, the present assay method can provide more complete assessment data using a single substrate, e.g. via providing a broader range of tumor characteristics, to, for example, guide therapy selection. In human and animal drug development programs, the apparatus and method can be used to better assess therapeutic candidate effects. The present invention can also be used for, among other things, analysis of biological interactions between nucleic acids and proteins which could be better characterized if studied in concurrent different types of probe-target assays, compared to using separate assays separated in time.

In accordance with various embodiments of the invention, an assay method includes deposition or in-situ synthesis of the various probe elements of different types, which comprise an array or group of arrays, on a common support. In accordance with various aspects of these embodiments, the method further includes preparation and delivery of a target biological sample in a form suitable for simultaneous and/or sequential detection, the detection methods for connection/attachment/hybridization of target to probe, and the use of such arrays in automated systems for research or diagnostic applications. In accordance with further aspects of these embodiments, various elements of cells and tissues are extracted and prepared for parallel target preparation, to gather concurrent and/or sequential assay data.

In accordance with additional embodiments of the invention, an array includes probes of multiple types attached to a single substrate. In accordance with various aspects of these embodiments, the probes are configured for: concurrent and/or sequential measurement of a single nucleotide polymorphism and the associated change in protein expression within a given sample, concurrent and/or sequential analysis of the impact of microRNA's on gene and protein expression within a given sample, and concurrent and/or sequential analysis of hypermethylation with gene expression.

In accordance with yet additional embodiments of the invention, multiple arrays, having different probe types are attached to a single substrate. In accordance with various aspects of these embodiments, the probes are configured for: concurrent and/or sequential measurement of a single nucleotide polymorphism and the associated change in protein expression within a given sample, concurrent and/or sequential analysis of the impact of microRNA's on gene and protein expression within a given sample, and concurrent and/or sequential analysis of hypermethylation with gene expression.

### BRIEF DESCRIPTION OF THE DRAWINGS

Additional aspects of the present invention should become evident upon reviewing the non-limiting embodiments described in the specification taken in conjunction with the accompanying figures, wherein like numerals designate like elements, and:

FIGS. 1-4 and 5(a)-5(b) illustrate exemplary multi-mode array configurations in accordance with various embodiments of the invention;

FIG. 6 illustrates a multi-mode array, including intermediates and additional groups, in accordance with various embodiments of the invention; and

FIGS. 7-12 illustrate assays in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

The following descriptions are of exemplary embodiments of the invention only, and are not intended to limit the scope, applicability or configuration of the invention in any way. Rather, the following description is intended to provide a convenient illustration for implementing various embodiments of the invention. As will become apparent, various changes may be made in the arrangement of and content of the arrays described herein without departing from the spirit and scope of the invention. For example, various probes may be patterned as described below or in other suitable configurations.

The apparatus and methods of the present invention can be used for a variety of purposes. By way of examples, the apparatus and methods have significant utility in the fields of genetic research, human disease management, human disease clinical research, human disease drug development and pharmacogenomics, human genetic research, animal drug development, animal disease management, animal genetic research, and plant genetic research. In particular, by enabling more informational analyses of biological and/or chemical samples using probes of multiple types on a single substrate, the invention provides improved disease management through more tailored diagnosis and therapy selection.

The methods and apparatus of the invention are particularly useful for disease management of cancer and other disease. For example, the invention can be used for categorizing genotype and phenotype of cancer. Once the tumor tissue genotype and phenotype are categorized by the method of the invention, a physician can combine this data with other clinical data to determine diagnosis, prognosis, therapy, and/or predict a response to therapy.

Definitions. The following definitions and abbreviations are used herein.

DNA—deoxyribonucleic acid, in either single- or double-stranded form, including analogs that can function in a similar manner.

RNA—ribonucleic acid in either single- or double-stranded form, including analogs that can function in a similar manner.

“Probe element” or “probe” refers to a region on or within the support that contains immobilized or attached probe materials listed herein, capable of attachment to an isolate from a biological sample either directly or via additional intermediate molecules. Probe elements may be natural or synthetic.

“Array” is used interchangeably with “microarray” and refers to a multitude of the same or different probe elements on the support.

“Target” is a chemical element or compound or biological molecule that has an affinity for and/or interacts with one or more probe elements. The target material may be natural or synthetic and in an unaltered state or altered state to facilitate analysis of a specimen. A target may interact with a probe element through a chemical reaction and/or covalent or other forms of bonding.

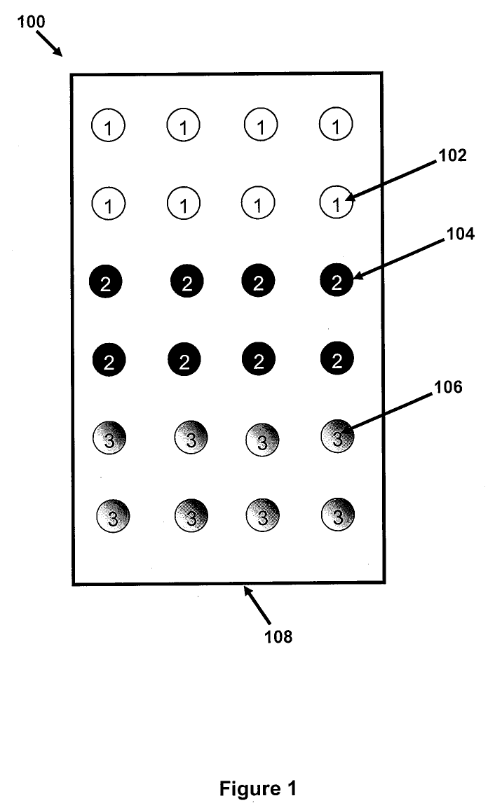

FIGS. 1-5 illustrate a multi-mode array 100, including a plurality of probes 102-106 on a support or substrate 108. Generally, multi-mode array 100 includes probes 102-106 of various, multiple types to facilitate evaluation of multiple targets using a single array. As explained in more detail below, array 100 allows quick and relatively inexpensive analysis of multiple targets using a single array. As a result, more information can be obtained using relatively less time and expense compared to traditional techniques. And, less sample is required to obtain the information.

Support 108 can be of various dimensions and materials, be porous or non-porous, and maybe comprised of multiple materials, multiple layers of material, or a matrix of materials and may be a two-dimensional surface or a three-dimensional material. When porous materials are used, the probe materials may be located at any location throughout the surfaces and interior regions of the porous material. Exemplary support materials include glass, colloidal materials, semiconductor materials, and plastics. Specific support material examples include silicon, and silicon coated with materials such as silicon oxide, polymers, and other films which promote aspects of the probe attachment and assay performance. The support may also include cell or tissue samples, which may be present prior to or subsequent to deposition or synthesis of the probes.

Probes 102-106 of the multi-mode array 100 can include a variety of probe materials, such as nucleic acid sequences, for example, nucleic acid or nucleic acid analog, including without limitation, DNA, RNA, locked nucleic acid (“LNA”) type, peptide nucleic acid (“PNA”) type. The nucleic acids in the probe elements may be of any length, and include additional chemical groups at the ends or in the body of the nucleic acid chain. By way of illustrative examples, probes 102-106 may include any combination of two or more of (i) DNA (all forms, single or double strand, natural or synthetic), (ii) RNA (all forms, single or double strand, natural or synthetic), (iii) oligonucleotides, (iv) PCR (“polymerase chain reaction”) amplicons, (v) LNA (locked nucleic acid), (vi) PNA (peptide nucleic acid), (vii) TNA (threose nucleic acid), (viii) PMO (phosphorodiamidate morpholino oligo), (ix) proteins (natural or synthetic), (x) peptides (natural or synthetic), (xi) carbohydrates, (xii) polysaccharides, (xiii) cells, (xiv) tissues, (xv) antibodies, (xvi) antigens, (xvii) protein-DNA complexes, (xviii) protein-RNA complexes, (xix) protein-protein complexes, (xx) DNA-RNA complexes, (xxi) aptamers, (xxii) dyes and dye complexes, (xxiii) stains, (xxiv) enzymes, (xxv) ubiquitin, and ubiquitinylated proteins, and (xxvi) reagents to promote probe-target reactions.

Probes 102-106 can be of varying dimension, shape, area, spacing and volume. Probes 102-106 can comprise physically separated spots produced by printing methods, for example, mechanical transfer, engraving, contact or non-contact print methods.

Probes 102-106 may be attached to support 108 by any suitable physical, chemical, or biological methods. For example, probes 102-106 may be attached using probe elements that are previously prepared and deposited in liquid, gel, or solid form on to the multi-mode array support via contact printing, or non-contact printing, or stamping, or electrospray, or acoustic ejection of droplets. By way of examples, probes 102-106 are synthesized on the multi-mode common support using chemical synthesis, light-stimulated synthesis, electrically-stimulated, magnetically-stimulated synthesis, or combinations thereof. The probes may be deposited inside or on the surface of channels within the common support through which liquids or gases are transported. The probes may also be conjugated with or attached to other materials, in order to provide attachment to either the support or the target or intermediate molecules, discussed in more detail below, between target and probe.

Probe 102-106 element density can be any desired density. For example, probe elements density may be in the range of 0.1 to 10,000,000 per square centimeter. Some or all of probes 102-106 can be closely abutted such as those produced by optical, electrical, chemical, magnetic, or acoustic stimulation of in-situ probe synthesis. Multiple probe elements may be co-located, either by being deposited as mixtures, or being later mixed by the sequential deposition of probe materials on to other previously deposited or synthesized probe materials.

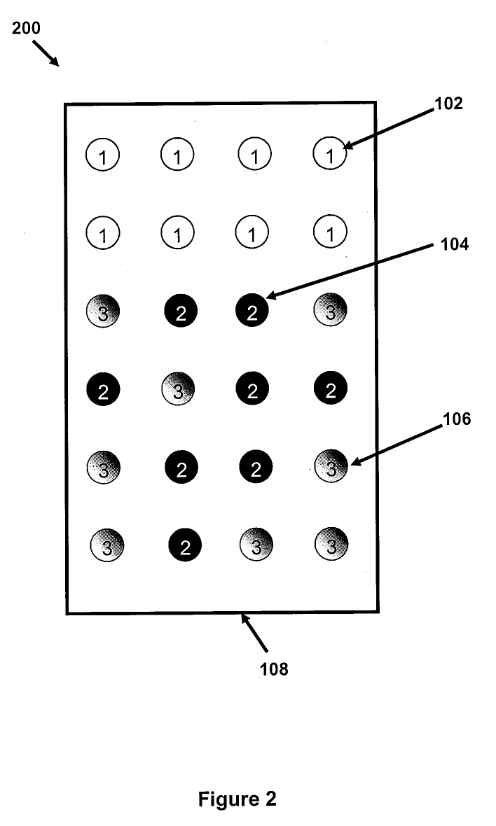

Referring again to FIGS. 1-5, probes 102-106 may be arranged on a surface of substrate 108 in a variety of configurations. For example, as illustrated in FIG. 1, probes of a like type may be arranged in rows. Alternatively, as illustrated in FIG. 2, an array 200 may include some of probes 102-106 that are grouped together (e.g., probes 102) and other probes 104, 106 on substrate 108 that are interspersed. Mixing or interspersing probes 102-106 may be desirable when a target material is confined to a limited area or volume or to support a collection of statistically significant data that minimizes any systemic error associated with different regions of support 108.

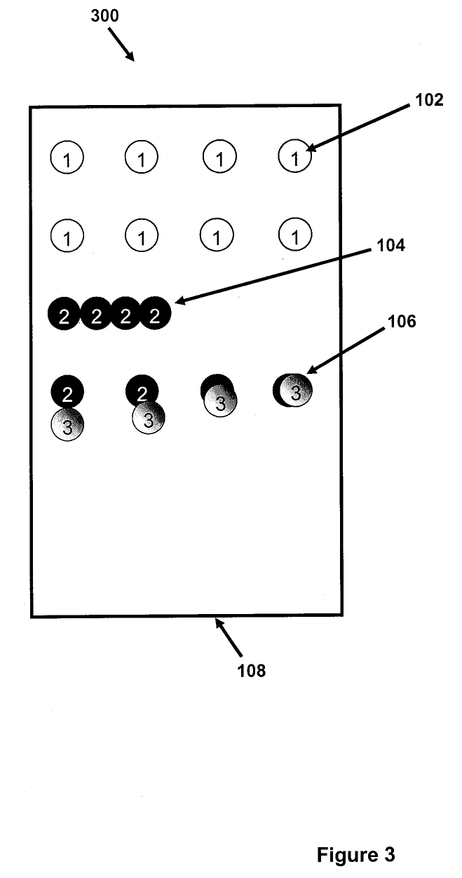

FIG. 3 illustrates yet another configuration of an array 300. In this case, array 300 includes probes 102 that are grouped together and isolated from each other, probes 104 that abut and/or overlap (partially or completely), and probes 104 and 106 that abut or overlap (partially or completely). Overlapping or abutting probes of a different type may be advantageous because such an arrangement may increase a total probe volume per substrate area and/or encourage otherwise missing or chemical reaction of more than one probe type.

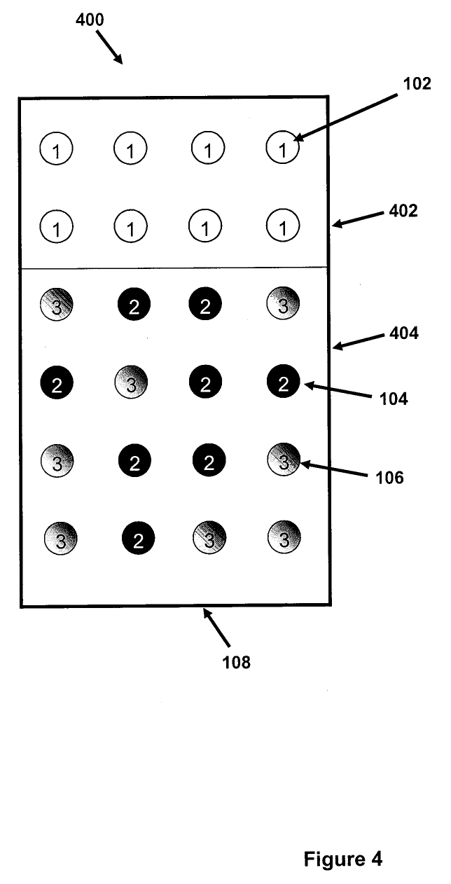

FIG. 4 illustrates another array 400 in accordance with yet additional embodiments of the invention. Array 400 includes a first region 402 and a second region 404, which may be treated differently from one another. Treatment refers to physical or chemical modifications on or within the common support or the addition of materials on or within the common support. Treatment may also refer to an area of a support that is used for another type of test and contains material for that type of test—for example, a treatment may be samples and/or preparations used for immunohistochemistry or pathology tests. Generally, the treatments are designed to optimize assay parameters. In the illustrated example, probes 102 are located on or within a first treatment (e.g., a polymer) and probes 104, 106 are located on or within a second treatment (e.g., an epoxysilane).

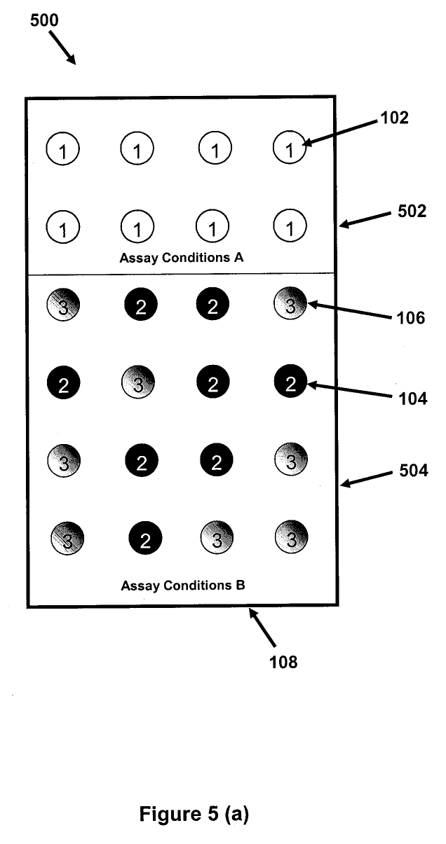

FIGS. 5(a) and 5(b) illustrate additional arrays 500 and 550 in accordance with yet additional embodiments of the invention. Array 500 includes a first isolated section 502 and a second isolated section 504, which allow for separate assay conditions for each section. Isolation refers to physical, thermal, chemical, radiation, or a combination thereof isolation between the section and another section or another area on support 108. Advantages of isolation include cost reduction, minimizing target sample quantities, tailoring assay chemistries and other assay conditions to the requirements of particular probe-target combinations, and the like.

Array 550 includes regions 552, 554, and 556 and probes 102-104 formed using different manufacturing techniques. For example, on or within the same support, combinations of deposition, printing, and/or in-situ synthesis may be used for different regions 552-556 of the multi-mode array 550. This may be advantageous to optimize the probe-target assay reactions for specific combinations. This technique can also be used to create additional regions within an established technology, e.g. to create a region for spotted protein arrays in an isolated region of the same common support as an in-situ synthesized nucleic acid array.

Arrays in accordance with the present invention (e.g., arrays 100-500 and 550) may also include intermediate compounds to achieve the desired attachment characteristics. Exemplary intermediate materials include, but not limited to, beads, nanofibers, nanoparticles, polymers, plastics, metals, and colloids. The probes may be deposited onto such materials, deposited over the materials on substrate 108, or synthesized in-situ with the intermediates. Additional intermediate materials may be attached to the ends or the body of the probe to promote various aspects of the probe attachment, multi-co-located probe methods, or probe-target assay.

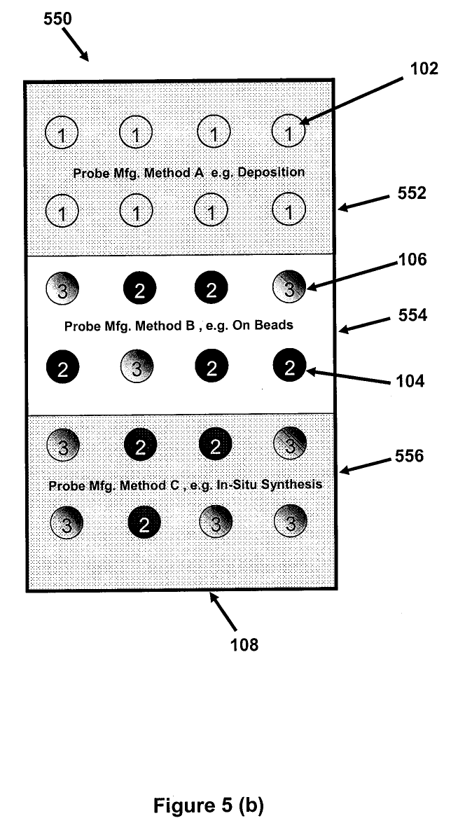

FIG. 6 illustrates a multi-mode array 600 with various probes 602-608 attached to a substrate 610 and various possibilities of probe construction. As illustrated, probe 602 is attached directly to substrate 610, probe 608 is attached to substrate 610 using one or more intermediates 612, probe 606 is attached to substrate 610 using one or more intermediates 614 and an additional intermediates 616 attached to at least a portion of probe 606, and probe 618 is attached to substrate 610 using one or more intermediates 618 and intermediates 620 and additional groups 622 are attached to at least a portion of probe 608. The additional groups may promote aspects of the assay or attachment of other probes in the same or an abutted location.

Although specific configurations are illustrated in FIG. 6, alternative arrangements of probes, intermediates, and additional groups also fall within the scope of the present invention. Further, although illustrated with one intermediate on one or more sides of a probe, multiple intermediates may be interposed between the probe and the substrate or located on another surface of the probe. Exemplary materials suitable additional groups 622 include chains of nucleotides, proteins, polymers, dyes, and the like.

Arrays in accordance with the present invention (e.g., multi-mode array 100-500 and 550) can be manufactured using a variety of techniques, including robotic deposition and in-situ synthesis methods (or combinations thereof) for array manufacturing. As noted above, microarrays comprising combinations of probe elements can be produced in any suitable arrangement. By way of example, nucleic acid elements can be located in one portion of an array or can be interspersed among protein probe elements.

The methods and apparatus of the present invention may be used to analyze a variety of chemical and biological materials. Target biological sample populations can be derived from any biological source, including human, plant and animal tissue. The tissue sample comprises any tissue, including a newly obtained sample, a frozen sample, a biopsy sample, a blood sample, an amniocentesis sample, preserved tissue such as a paraffin-embedded fixed tissue sample (i.e., a tissue block), or a cell culture. Thus, the tissue sample can comprise a whole blood sample, a skin sample, epithelial cells, soft tissue cells, fetal cells, amniocytes, lymphocytes, granulocytes, suspected tumor cells, organ tissue, blastomeres and polar bodies. The tissue to be tested can be derived from a micro-dissection process. In general, more controls should be used with PCR to avoid or identify any artifacts introduced.

Specific exemplary target materials include DNA (all forms, single or double strand, natural or synthetic), RNA (all forms, single or double strand, natural or synthetic), oligonucleotides, PCR amplicons, proteins (natural or synthetic), peptides (natural or synthetic), carbohydrates, polysaccharides, cells, tissues, antibodies, antigens, metals, moieties, methylated DNA, CpG islands, protein-DNA complexes, protein-RNA complexes, protein-protein complexes, DNA-RNA complexes, phosphorylated DNA, microRNA, aptamers, chromosomal abnormalities, single nucleotide polymorphisms, and ubiquitin, and ubiquitinylated proteins.

The target may also already be present on or within the common support, and transported to the array section by physical or chemical or fluidic or electrical or magnetic methods, for subsequent probe-target reaction on one or more of the probe array regions on the support. For example, following cell testing, or blood testing, or immunohistochemistry testing of a tissue sample, the sample may be treated with reagents to make it suitable as a target material for the probes on the common support.

When analyzing samples, the labels used can be any suitable marker detectable by any detection method. For example, the target(s) may be detected using the same or different labeling technology on the same multi-mode array, including labeling via fluorescence, quantum dots, chemiluminescence, electrical, magnetic, radioactive, and colorometric

The target materials isolated from the biological sample are hybridized to the probes on the array under suitable hybridization and labeling conditions selected to permit detection of targets. The hybridization and labeling conditions include choice of time, temperature, chemistry, ambient environment.

In accordance with various embodiments of the invention, detection of multiple biological conditions using combinations of more than one probe type as described herein includes the steps of providing an array or group of arrays and providing detection capability for the target(s). In accordance with various aspects of these embodiments, a method for assaying a multi-mode microarray, which allows for concurrent and/or sequential target-probe reactions to more than one of the probe types includes (a) providing sample preparation, hybridization, labeling and detection techniques to detect and/or quantify the reaction between the various types of targets and probes on the array, (b) providing isolation of the segments of the multi-mode array, if required or advantageous, during the hybridization process, and (c) providing software to analyze the various probe types on the multi-mode array.

In accordance with further aspects of methods of assay analysis, hybridization and labeling reactions can either occur: concurrently using conditions which allow for independent hybridization and labeling of the multiple probe-target combinations; sequentially, using conditions which allow for the individual probe-target combinations to be analyzed; using manual or automated methods to achieve the hybridization and labeling conditions; unlabeled hybridization reactions are permitted under the invention; before, concurrently with, or subsequent to another type of test performed on the same support, e.g. but not limited to, a tissue test such as an immunohistochemistry test performed on the same or another area of the support. Products from the other types of test may be delivered to other areas of the common support which contain probes on arrays.

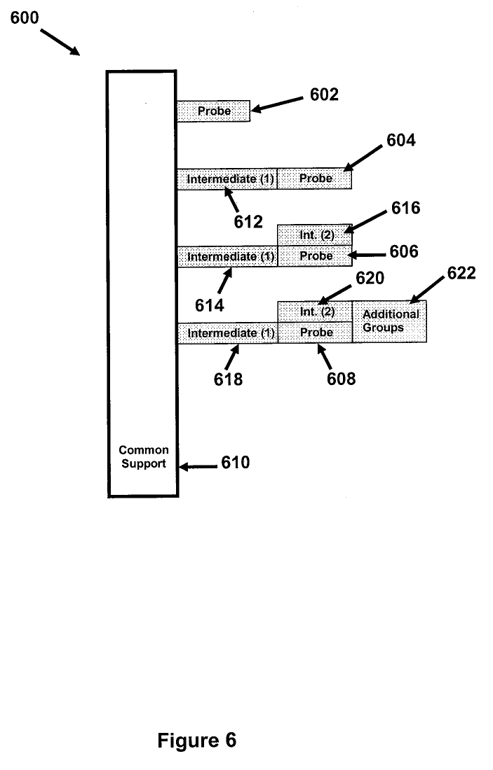

FIGS. 7-12 illustrate array assays in accordance with various exemplary embodiments of the invention. FIG. 7 illustrates delivery of a target material 702 to a multi-mode array 704. Target material 702 for the various probe-target assay reactions may be delivered as a single mix to the various regions of the common support, concurrently and/or sequentially. The various reagents, labels, and other components of the target mix may be delivered in multiple steps.

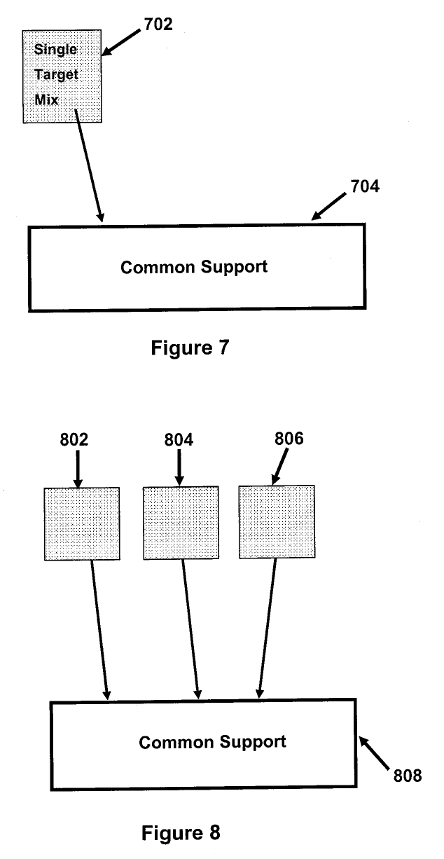

FIG. 8 illustrates delivery of target material to a multi-mode array 808, wherein the target material 802-806 for the various probe-target assay reactions are delivered as multiple distinct material or mixes to the various regions of common support 808, either concurrently or sequentially. The various reagents, labels, and other components of the target mix may be delivered in multiple steps.

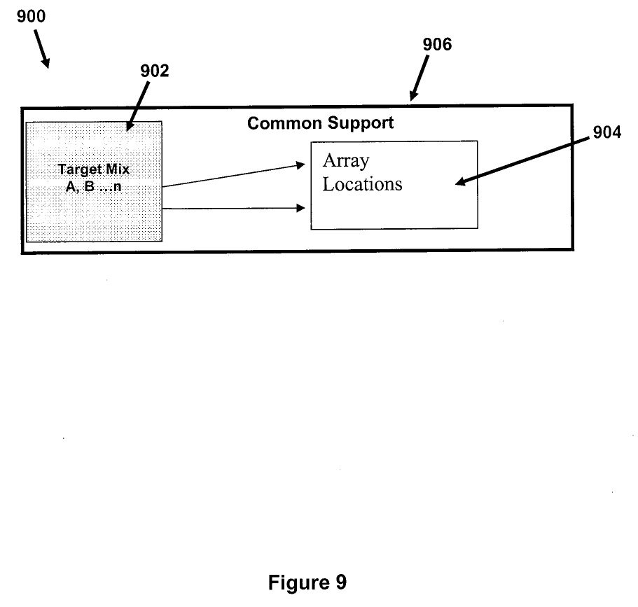

FIG. 9 illustrates another delivery system 900 in accordance with additional embodiments of the invention. In this case, target material 902 for the various probe-target assay reactions may be derived from another area of the common support 906, and transported to one or more probe array regions 904. The various reagents, labels, and other components of the target mix may be delivered in multiple steps.

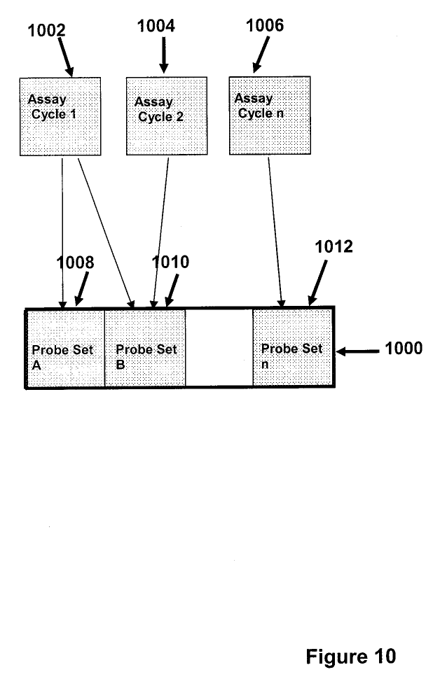

FIG. 10 illustrates a technique of using multiple assay conditions 1002-1006 on multiple sections 1008-1012 of array 1000. In the illustrated case, for each of the probe sets 1008-1012, different assay conditions may be applied, concurrently or sequentially. Assay conditions include, but are not limited to; time, temperature, chemical environment, labeling conditions, vibration, acoustic environment, lighting conditions, electrical conditions, and magnetic environment. Multiple and different assay cycles may be applied to any set of probes.

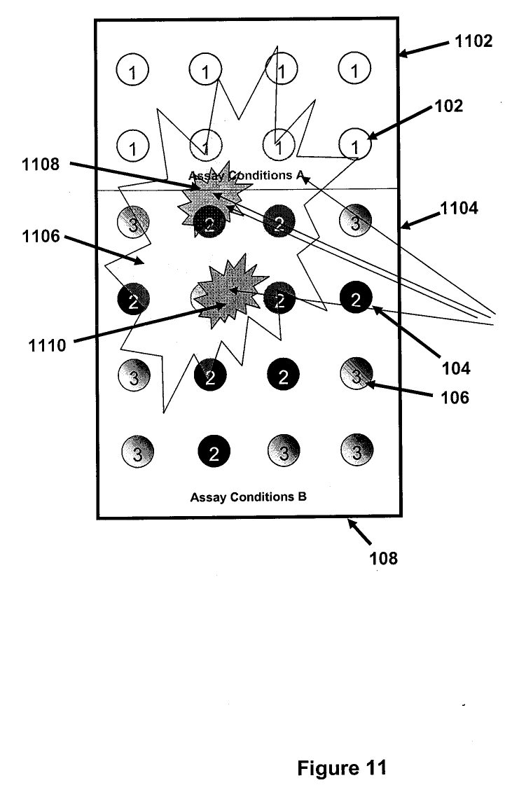

FIG. 11 illustrates another technique for analyzing tissue using an array including a first region 1102, having probes 102 of a first type and a second region 1104, having probes 104 and 106 of a second and third type. In this case, probes 102-106 may be located below, within, or above a tissue sample containing multiple regions 1108, 1110 and compositions, e.g., healthy tissue regions and diseased tissue regions. Tissue samples 1106 may be treated in a way which releases target materials, such as DNA (all forms, single or double strand, natural or synthetic), RNA (all forms, single or double strand, natural or synthetic), PCR (“polymerase chain reaction”) amplicons, proteins (natural or synthetic), peptides (natural or synthetic), carbohydrates, polysaccharides, cells, tissues, antibodies, antigens, protein-DNA complexes, protein-RNA complexes, protein-protein complexes, DNA-RNA complexes, aptamers enzymes, ubiquitin, and ubiquitinylated proteins, These target materials may then be used for target-probe reactions in any region of the common support.

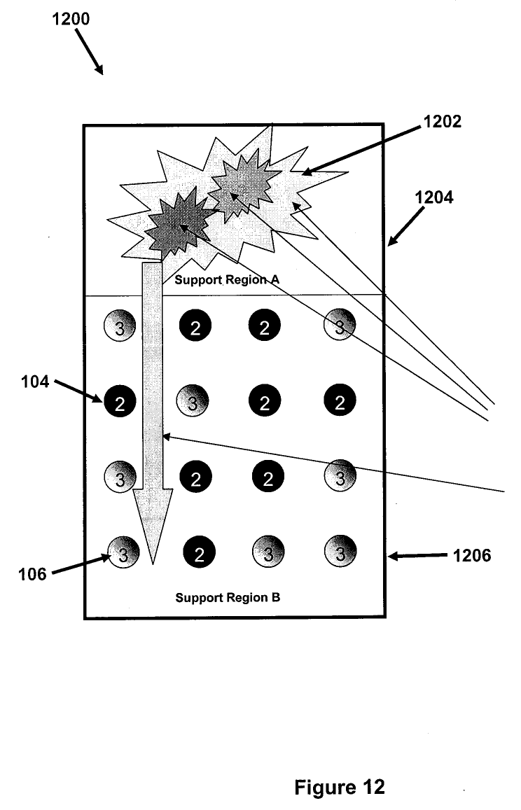

FIG. 12 illustrates yet another technique for evaluating target material 1202 (e.g., tissue material). In the illustrated example, array 1200, includes a first region 1204 and a second region 1206, including probes 104, 106. Tissue sample 1202 may be treated in a way which releases target materials, such as DNA (all forms, single or double strand, natural or synthetic), RNA (all forms, single or double strand, natural or synthetic), oligonucleotides, PCR (“polymerase chain reaction”) amplicons, proteins (natural or synthetic), peptides (natural or synthetic), carbohydrates, polysaccharides, cells, tissues, antibodies, antigens, protein-DNA complexes, protein-RNA complexes, protein-protein complexes, DNA-RNA complexes, aptamers, enzymes, ubiquitin, and ubiquitinylated proteins. These targets may be transported to any region of the common support where probes are located, for target-probe assay reaction.

Array Detection

After hybridization, the fluorescence presence and intensity for each label color is detected and determined by any suitable detector or reader apparatus and method, compatible with detection of the label (if present) or the hybridization event. The process may be automated or manual assay system, which can vary the assay conditions, and independently deliver different reagents and target mixes, within various regions of the multi-mode array to support sequential hybridization and/or chemical reaction. An assay may performed in an integrated sample-to-answer cartridge type device of any dimensions, or a Lab-on-Chip assay device, constructed using plastics, ceramics, silicon technologies, or nanomaterials. The data obtained from the multiple modes of the multi-mode array may be analyzed in a programmed computer, or raw and/or processed data may be stored in a database and displayed in raw and/or processed form.

### EXAMPLES

The Examples set forth hereinbelow are illustrative of various aspects of certain exemplary embodiments of the composition used in the applicator system of the present invention. The compositions, methods and various parameters reflected therein are intended only to exemplify various aspects and embodiments of the invention, and are not intended to limit the scope of the claimed invention.

### Example 1

An exemplary array is formed by attaching three types of probes on a common substrate. This substrate is composed of a standard glass microscope slide coated with a polymer film. Deposited probes consist of 30-mer oligonucleotides to evaluate messenger RNA expression, 22-mer oligonucleotides to evaluate microRNA expression, and antibodies to evaluate protein expression from the same original biological sample or a mixture of samples. This combined analysis may be used to provide information on a biological pathway, or be used to provide a particular disease diagnosis. The results may be obtained using less sample material than if using three individual array analyses, and provide data which is not confounded by variations between samples.

### Example 2

An exemplary array is formed by attaching oligonucleotides on to a glass microscope slide coated with a nitrocellulose film in one region, and a polymer film in another region. Arrays of 50-mer oligonucleotide probes to evaluate messenger RNA expression are deposited in both regions. Arrays of 30-mer oligonucleotide probes are deposited in both regions to evaluate genotype. Arrays of antibodies are deposited in both regions to evaluate protein expression. Target material consisting of single or multiple cells or tissue is applied to the substrate, and optionally evaluated by standard cell analysis or immunohistochemistry analysis. Subsequently the sample tissues and cells are treated such as to release DNA, RNA (messenger RNA, total RNA, mitochondrial RNA, microRNA, and other RNA's), and proteins. These materials hybridize to the capture probes on the array and are available for analysis.

### Example 3

An exemplary array is formed on a glass microtiter plate coated with an epoxysilane film, and divided into 96 or 384 individual areas. 50-mer oligonucleotide probes are deposited, to capture messenger RNA's. 22-mer oligonucleotide probes with a different attachment molecule are deposited, to capture microRNA's. The sample is treated to prepare both types of RNA, and those RNA's are subsequently detected on the multi-mode microarray.

The present invention has been described above with reference to a number of exemplary embodiments and examples. It should be appreciated that the particular embodiments shown and described herein are illustrative of the invention and its best mode and are not intended to limit in any way the scope of the invention as set forth in the claims. Those having read this disclosure will recognize that changes and modifications may be made to the exemplary embodiments without departing from the scope of the present invention. For example, various array configurations that are not specifically illustrated in the figures still fall within the scope of the present invention. Accordingly, these and other changes or modifications are intended to be included to be within the scope of the present invention, as expressed in the following claims.

I claim:

1. A method for detection of multiple targets of different types using a multi-mode array on a common support, the method comprising the steps of:
(a) providing an array with probes on a support, the array comprising a combination of two or more of the following types, on or within a common support; and
(i) DNA (all forms, single or double strand, natural or synthetic),
(ii) RNA (all forms, single or double strand, natural or synthetic),
(iii) oligonucleotides,
(iv) PCR (“polymerase chain reaction”) amplicons,
(v) LNA (locked nucleic acid),
(vi) PNA (peptide nucleic acid),
(vii) TNA (threose nucleic acid),
(viii) PMO (phosphorodiamidate morpholino oligo),
(ix) proteins (natural or synthetic),
(x) peptides (natural or synthetic),
(xi) carbohydrates,
(xii) polysaccharides,
(xiii) cells,
(xiv) tissues,
(xv) antibodies,
(xvi) antigens,
(xvii) protein-DNA complexes,
(xviii) protein-RNA complexes,
(xix) protein-protein complexes,
(xx) DNA-RNA complexes,
(xxi) aptamers,
(xxii) dyes and dye complexes,
(xxiii) stains,
(xxiv) enzymes,
(xxv) ubiquitin, and ubiquitinylated proteins,
(xxvi) reagents to promote probe-target reactions
(b) providing the detection capability for target molecules and phenomena of the following types, individually or in combination:
(i) DNA (all forms, single or double strand, natural or synthetic),
(ii) RNA (all forms, single or double strand, natural or synthetic),
(iii) oligonucleotides,
(iv) PCR amplicons,
(v) proteins (natural or synthetic),
(vi) peptides (natural or synthetic),
(vii) carbohydrates,
(viii) polysaccharides,
(ix) cells,
(x) tissues,
(xi) antibodies,
(xii) antigens,
(xiii) metals,
(xiv) moieties,
(xv) methylated DNA,
(xvi) CpG islands,
(xvii) protein-DNA complexes,
(xviii) protein-RNA complexes,
(xiv) protein-protein complexes,
(xx) DNA-RNA complexes,
(xxi) phosphorylated DNA,
(xxii) microRNA
(xxiii) aptamers,
(xxiv) chromosomal abnormalities,
(xxv) single nucleotide polymorphisms,
(xxvi) ubiquitin, and ubiquitinylated proteins

2. The method of claim 1 wherein the common support is divided into multiple regions.

3. The method of claim 1 wherein the common support comprises a porous material, composed of single or multiple materials, and the probe materials are located at any location throughout the surfaces and interior regions of the porous material.

4. The method of claim 1 wherein the step of providing the detection capability further comprises providing probes that are deposited inside or on the surface of channels within the support-through which liquids or gases are transported.

5. The method of claim 1 wherein the support contains cell or tissue samples, prior to deposition or synthesis of the probes.

6. The method of claim 1 wherein probes are synthesized on the support, using chemical synthesis, light-stimulated synthesis, electrically-stimulated, magnetically-stimulated synthesis, or a combination thereof.

7. The method of claim 1 wherein the probes are previously deposited on beads, nanoparticles, or nanofibers, or synthesized in-situ on beads, nanoparticles, or nanofibers.

8. The method of claim 1 wherein multiple probes are deposited as a mixture, or mixed at a particular location by the deposition method.

9. The method of claim 1 wherein the probes are conjugated with or attached to other materials, in order to provide attachment to either the support or the target or intermediate molecules between target and probe.

10. The method of claim 1 wherein one or more probes may be used on the same support that is employed for different types of biological sample testing, such as immunohistochemistry, and wherein the probes may be deposited before, during or after the other test method, on the same or different region of the support as used for the other test.

11. The method of claim 1 wherein multiple probes are located in the same physical location through some of the probes being synthesized, and others being deposited individually or as mixtures.

12. The method of claim 1 wherein the biological sample target comprises one cell.

13. The method of claim 1 wherein the biological sample target comprises a human or animal tumor or healthy tissue sample.

14. The method of claim 1 wherein the biological sample target comprises blood cells, saliva, spinal fluid, cerebral fluid, urine or stool.

15. The method of claim 1 wherein the various probe-target reactions may be detected using the same or different labeling technology on the same multi-mode array, including labeling via fluorescence, quantum dots, chemiluminescence, electrical, magnetic, radioactive, and colorometric labels.

16. The method of claim 1 wherein the assay is performed in an integrated sample-to-answer cartridge type device of any dimensions, or a Lab-on-Chip assay device, constructed using plastics, ceramics, silicon technologies, or nanomaterials.

17. The method of claim 1 wherein the target material is already located on one area of the common support, may be used for another type of test, and during the assay process is transported to the probes arrays sections of the common support.

18. The method of claim 1 further comprising use of data derived from the method in selection of therapy for a human or animal, or treatment of plants or crops.
